(19) United States
(12) Patent Application Publication
(10) Pub. No.: US 2008/0021651 A1
(43) Pub. Date: Jan. 24, 2008

(54) Performance Assessment and Information System Based on Sports Ball Motion

(75) Inventors: John Richard Seeley, Saint Augustine, FL (US); Michael Joseph Pastore, Encinitas, CA (US)

Correspondence Address: John Richard Seeley Jr, 1217 Garrison Drive, St. Augustine, FL, 32092, US

(73) Assignees: John Richard Seeley, Saint Augustine, FL (US); Michael Joseph Pastore, Encinitas, CA (US)

(21) Appl. No.: 11/778,032

(22) Filed: Jul. 14, 2007

Related U.S. Application Data
(60) Provisional application No. 60/807,710, filed on Jul. 18, 2006.

(51) Int. Cl. G06F 19/00; G01B 21/16; G01W 1/02

(52) U.S. Cl. 702/3; 702/152

(57) ABSTRACT

Disclosed is an integrated sports assessment and information invention, applicable to most sports, designed to measure, calculate, derive, and analyze the resultant sport ball movement and ball-orientation characteristics in order to provide an assessment of the player's performance and the circumstances surrounding the conduct of the sports action. The observed position and motion characteristics of the ball are continuously and empirically determined using measured data, environmental factors affecting the ball's position and orientation are measured or derived. Related data is collected, stored, manipulated, and analyzed using 1^{st}, 2^{nd} and higher order statistics to generate output products for display of single or multiple occurrences based on any sport appropriate criteria. State-of-the-art display techniques provide the player, instructor or observer with valuable information regarding the player's performance, the impact of the player's action(s) or related circumstances on the ball's travel-path that will enhance performance, understanding and enjoyment of the sport.

### CROSS-REFERENCE TO RELATED APPLICATIONS

This applications claims priority to U.S. Provisional Application No. 60/807,710 which was filed Jul. 18, 2006 and titled “Ball Tracking and Performance Analysis System”. This Provisional Patent Application provides for the basic concepts and intent of the invention described in this paper and benefit is claimed by incorporation into this document.

### STATEMENT REGARDING FEDERALLY SPONSORED REASEARCH OR DEVELOPMENT

Not Applicable

### THE NAMES OF PARTIES TO A JOINT RESEARCH AGREEMENT

Not applicable

### REFERENCE TO SEQUENCE LISTING, A TABLE, OR COMPUTER PROGRAM LISTING COMPACT DISC APPENDIX

Not Applicable

### BACKGROUND OF THE INVENTION

1. Field of the Invention

The field of endeavor to which this invention pertains is the conduct of a sport action by a player(s), the characterization of the circumstances surrounding this action and the result of the action and surrounding circumstances on the motion or action of the sport ball with respect to the general conduct of the sport, the player's performance and/or instructional level and overall viewing of the sport event by any interested observer. It particularly relates to Education and Demonstration, for a means specifically adapted to teach or instruct a person in some aspect of a game or sport which involves physical activity and for a game which tests the skill of a person in accomplishing some sought result. It also is applicable in the area of Amusement Devices: Games, in subclasses concerned with an aerial projectile game. The device is used for instruction and practice or perfecting game skills as well as entertainment for an audience.

In sport games where a player interacts with a ‘sports-object’ (henceforth referred to as a ‘ball’) that causes ball motion, this interaction results in success or failure in the game. For this reason a player seeks instruction and spends long practice hours evaluating different actions on the ball to hone skills for game situations. Also, in most outdoor ball games, the in situ environmental conditions of the game ‘field’ and environmental factors such as wind speed, temperature, humidity, etc. can critically impact the travel-path of the ball after it has been put into motion by a player. As a result, a player and/or instructor/coach desire(s) a quantitative methodology that can assess the motion of a sports ball as function of a player's action and as a function of the in situ environment on the game field. In addition broadcast and/or internet and/or film and/or other media audiences desire detailed insight into a player(s) action on a ball.

One way to implement this assessment methodology is to obtain a high fidelity track of the travel-path of the ball during the time period of interest while accounting for specific player actions and while measuring the in situ environmental effects that impact the motion of the ball. If these functions are incorporated into a system that stores many repetitive sports action results during practice situations, then many data sets of a player's techniques can be obtained. The system can then statistically analyze the accumulated data sets and display the results in a tutorial fashion for use by a player(s) and/or instructor(s) and/or coach(s) to determine the optimum technique. The same system could be used in game situations to capture actual sports action for instructional purposes during the game and/or for post-game tutorial use. In addition, such a system can be used to provide in depth analysis of sports actions during a game for a viewing audience.

To a varying degree all sports have a need to identify the location of the ‘ball’ during play. In most cases it may be just be a matter of identifying whether a ball is in the ‘field’ of play or off the ‘field’ of play such as for tennis, volleyball, golf, baseball, and football. However, many players, coaches, instructors, and observers for the above sports and other sports desire knowledge of the travel-path and spin of the ball as an instructional means to improve the participant's performance of the sport and/or to enhance viewing of the sport. For some sports even more detailed information is needed including such data as the exact trajectory of the ball over the entire course of its motion and various flight characteristics such as travel distance, flight apogee, and ball spin. This level of information is a critical factor in obtaining success in sports actions such as pitching a baseball or striking a golf ball. Obtaining high fidelity ball location data during a ball's entire period of motion requires point-by-point measurements during an actual game and/or at a practice location (henceforth generically designated as the ‘field’ for all sports playing and practice areas).

In most outside sports the in situ environmental situation on the field that impact the conduct of the sport are also of great importance. The most important of these environmental factors are usually field conditions and meteorological conditions on the field. The importance depends on the intensity of the conditions and on the sport. For example, the wind, temperature, and humidity parameters can have significant impact on the travel-path of a ball in tennis, golf, a batted baseball and a thrown/kicked football. These factors have some impact on any sport where the ball is put into flight and travels any measurable distance. Additionally, the condition of the playing field such as ground contour, surface hardness, grass length, wetness, etc can be a major factor and these factors must also be considered to fully characterize the environment within which or upon which the sport is being conducted.

The final component for this instructional invention is the circumstances and actions of the player in the initiation of the ball motion. Various aspects of the situation under which the player causes the ball motion are critical to the understanding of the reasons for the observed ball motion such as the type of bat or specific golf club and/or player's stance or arm movements.

These extensive and detailed observations are combined into a quantified analysis of the cause and effect relationship between the player actions, player circumstances, and environmental conditions that produced the observed and measured resultant ball motion. As a result, the player and/or instructor and/or observer are provided with a powerful and extremely useful tool in the characterization of the player's current state and level of performance. The tool outputs can be used in the assessment of future instruction and proficiency for improving a player's performance. Additionally, a player practicing the game and receiving the information provided by this invention can gain valuable insight into and understanding of the quantitative impact that specific circumstances and environmental conditions have on their performance of specific aspects of the sport. This level of feedback and information presents the potential for significantly improving the player's performance of the sport under similar circumstances and provides great benefit in adjusting to future and different conditions. State of the art computational devices, mathematical algorithm software, and electronic equipment are available or can be modified or developed to permit the invention's concepts to be implemented for commercial broadcast and/or other media and/or individual instructional training.

In order to perform certain aspects of the invention's proposed capabilities there may be a requirement for the insertion of an electronic device into the ball and/or make subtle physical modifications to the ball to permit full functioning of the invention. While current technology allows devices to be inserted into any ball while not affecting the Newtonian characteristics of the ball, the official rules of some sports prohibits any modification to an official game ball.

As an example, for major league baseball only baseballs manufactured under strict specifications of material and method are approved for use. For these sports the full scope of the invention's capability might only be available to a participant during instructional practice sessions and/or for certain sports leagues that allow such modifications to the game ball. However for golf, the acceptance of a ball by governing bodies of the sport depends on performance characteristics exhibited by the ball while undergoing specific tests. It is well within current manufacturing technology to insert a device as envisioned in this invention into a golf ball to obtain the characteristics required for the game. Implementation of the invention for each ball sport would require in depth examination of the rules governing the ball to determine whether an invention modified ball could be used in a game or just in practice.

A computational system is an important component to take advantage of a ‘ball’ tracking system and ball-orientation system data. The computational system must have the capability to store the data, manipulate the data, utilize existing environmental and tracking algorithms, and display the computed flight-path and modifications of the flight-path data including historical statistical results for a viewing audience and/or for instructional purposes during training.

2. Description of Related Art

There are a number of proposed devices and systems that can accomplish one or two of the proposed invention's functions with varying degree of success, utility and cost. Most of the existing systems for ball flight tracking are video-recording types of systems that optically track the sports ball. These systems are costly and difficult to install and use in a large variety of playing field. In addition, they do not determine the travel-path impact of environmental conditions, they do not provide ball-orientation during the travel-path, nor do these systems provide ball flight information such as ball launch angle, spin, and maximum height in flight. Video tracking systems descriptions are contained in U.S. Pat. No. 5,768,151, U.S. Pat. No. 6,042,492 and U.S. Pat. No. 6,233,492. U.S. Pat. No. 5,768,151 use video techniques to determine the trajectory of a ball for use in the development of a sports simulator. U.S. Pat. No. 6,042,492 uses video observation of a baseball to determine quantitative data for specific tests on a player. U.S. Pat. No. 6,233,007 uses video tracking to enhance television coverage of sporting events. None of these systems uses radio frequency equipments to perform ball tracking and ball motion (ball-orientation characteristic determination). None of these systems use in situ environmental measurements to determine their impact on the ball's location and ball-orientation characteristics. None of these systems claims to provide statistical analysis for providing quantitative output analysis of performance results for a player(s) and/or comparison among players.

The proposed invention is a radio frequency (RF) system. There is no RF system available that addresses all the proposed invention's claims. Systems using RF systems for ball location are addressed in patents such as U.S. Pat. No. 5,150,895, U.S. Pat. No. 5,423,549, U.S. Pat. No. 5,662,533, U.S. Pat. No. 5,662,534, U.S. Pat. No. 6,620,057 and U.S. Pat. No. 6,963,301. Determination of ball spin has been addressed by U.S. Pat. No. 6,151,563 and U.S. Pat. No. 6,157,898.

U.S. Pat. No. 5,150,895 claims to use a single commercial radar to determine the XYZ position coordinates of a ball during play. It is unclear how a single low-cost commercial radar can provide 3-dimentional XYZ positional data. U.S. Pat. No. 5,150,895 claims that ball spin can be obtained by use of segments of foil in the ball. The proposed invention differs from U.S. Pat. No. 5,150,895 for one of its RF energy sources by using two commercial radars, one for azimuthal bearing and range data and one for elevation angle and slant range data. In addition, the proposed invention uses in situ environmental measurements to determine their impact on the ball's location and ball-orientation characteristics and uses statistical analysis algorithms to providing quantitative output analysis of performance results for instructional use and audience appreciation. And the invention does not use foil strips for spin determination.

U.S. Pat. No. 5,423,563, U.S. Pat. No. 5,662,533, U.S. Pat. No. 5,662,534, and U.S. Pat. No. 6,620,057 are basically lost ball locator systems. They claim the ability to determine a general location of a ball after it is “at rest’ i.e. it has stopped moving. The proposed invention obtains much more precise locating information for a ball while it is in motion and it proposes to provide this information over the entire field of play.

U.S. Pat. No. 6,963,301 uses very low frequency RF near-field energy in a methodology for obtaining ball positional data. It is not clear how this technique would be able to detect small ball objects and, if it did, how it would provide the accuracy needed to determine the ball travel-path. The proposed invention does not claim to use this near-field methodology nor does it operate in the RF spectrum required for near field operations.

U.S. Pat. No. 5,423,549 and U.S. Pat. No. 6,151,563 claim the ability to determine the spin on a ball using an accelerometer device placed in the ball. The proposed invention differs from these Patents in that it does not claim nor require an accelerometer to obtain ball-orientation characteristics i.e. spin.

### BRIEF SUMMARY OF THE INVENTION

The proposed invention is an integrated system designed to provide all relevant and pertinent performance information relative to a sports related physical act by a player(s) (such as propelling, launching, hitting, throwing, or any equivalent action related to the sport of interest) on a sports ball used in sport games (‘ball’ will be used as a generic term for all sports objects including hockey puck, curling stone, discus, boxing glove, football, baseball, golf ball, etc). There are three primary functions of the invention. These functions are:
(i) a ball location system that uses RF transmissions and detections to obtain empirical point by point position and flight/motion characteristics such as spin of the sports ball along its entire travel-path, motion path and/or flight path and in the locations, venues and sites where the sport is normally played and/or practiced;
(ii) a method for the collection of the circumstances that define a player's action on the ball and the conditions surrounding the player's actions at the time motion is initiated and the characterization of the environmental conditions present across the playing field and along the path of ball motion by measurement or input by other means of the in situ environmental factors that could reasonably be expected to affect the ball motion; and
(iii) a method for the association and analysis and display of all data collected by the system and the generation of performance assessment and evaluative products for a single or multiple occurrences or episodes based on designated time periods, specific player(s) actions or player/sports related circumstances or any similar sport appropriate interval or criteria.

The invention provides player(s) and/or instructor(s) and/or coach(s) and/or sport observer(s) with information regarding the player(s) performance or impact of the related circumstances on the ball flight and a method for the display of measured data, derived information, analysis results or any combination of these that is appropriate for the sport being addressed which will provide valuable feedback with respect to the past or current performance level of the player(s), or will assist the player(s) in the performance of the sport related actions or will enhance a viewers or observers understanding and enjoyment of the sport with regard to the player(s) action and/or the balls resultant response. Finally, if necessary, the invention provides a means to collect balls containing the embedded device required for this application and quickly and automatically sort them from other balls that have not been modified and/or into appropriate categories of modified balls for future use.

The proposed invention includes many capabilities, functions, and resolves issues which not available or not adequately addressed by current state of the art devices. The invention improves on the previously described optical systems in that the specific invention claims are uniquely outside the optical ball tracking systems thus providing a more cost effective and easier to operate method than previously identified. Instead a number of the proposed invention features and functions provide enhancements to all existing video ball tracking systems such as the ball motion and flight characteristic data which is not available in the optical tracking systems.

The proposed invention improves on the systems and methods described in U.S. Pat. No. 5,150,895 by providing a realistic and inexpensive means for obtaining travel-path location data on almost any sport ‘ball’. The most costly method would be using two modified commercial 2-dimentional radars to obtain 3-dimentional positional data vice the proposed 3-dimentional radar used in U.S. Pat. No. 5,150,895. An alternative source of RF energy in the proposed invention is the use of an omni or directed RF pulse-transmitter which would be much less expensive than a 3-dimentional radar and, even, less expensive than two modified commercial 2-dimentional radars.

U.S. Pat. No. 5,150,895 proposes to obtain spin data by using foil strips embedded in a ball. The proposed invention does not use this technique. If it is necessary to use a modified ball the proposed invention uses a radar corner-reflector and/or RFID device and/or physical modifications to the ball's surface and/or subsurface to alter the signal characteristics of the impinging RF transmitted signal which would provide signal enhancement and resultant signal characteristic products not available from strips of foil in a ball.

Other capabilities, functions and/or items not in U.S. Pat. No. 5,150,895 but in the proposed invention are:
(i.) State-of-the-art tracking algorithms to provide accurate travel-path location data to obtain a high fidelity trajectory of the ball's flight and resultant bounces,
(ii.) Measurement of in situ environmental effects that impact the travel-path of the ball and to use in other modeling functions,
(iii.) Inclusion of 1^{st} and 2^{nd} and higher order statistics analysis algorithms to assess the results of ball travel-path performance, and
(iv.) Methodology to contour the field of play to ensure accurate 3-dimentional positional data.

U.S. Pat. No. 5,423,549, U.S. Pat. No. 5,662,33, U.S. Pat. No. 5,662,534, and U.S. Pat. No. 6,620,057 use RF energy to location a ball after it comes to rest i.e. the ball is stationary. The proposed invention provides the ability to detect the ball in motion and during flight in order to provide an accurate flight travel-path for the entire journey of the ball. Additionally, the proposed invention is envisioned to operate across an entire field of play with distances greater than those available in the current state of the art.

U.S. Pat. No. 6,151,563 and U.S. Pat. No. 6,157,898 propose to provide data on the spin of a ball. These patents propose using balls containing accelerometer devices. Such devices are cumbersome to use and require an energy source in the ball. If it is necessary to use a modified ball, the proposed invention describes the use of passive RF reflective devices and/or physical modifications to the ball's surface and/or subsurface in the ball that do not require an energy source which would make modifications to the ball cheaper and easier to implement as well as improve the scope of information available for description of the ball's motion characteristics.

None of the capabilities and methods contained in previous systems and in the current state of the art provides the comprehensive implementations and the depth and breadth of performance information and analysis that this invention claims. The invention presents a comprehensive and integrated system that includes ball travel-path tracking for determination of travel distance, apogee, launch angle, ball-orientation (spin) parameters and the inclusion of a quantified analysis of the impact and relationship of the resultant ball motion with the causal factors such as player action and circumstances and environmental conditions.

### BRIEF DESCRIPTION OF THE SEVERAL VIEWS OF THE DRAWING

FIG. 1 depicts a basic and illustrative equipment layout for the invention's equipment using the example of a golf driving or practice range. It shows a sample layout of the envisioned equipment across the field including RF Pulse transmitters, receivers and/or transceivers and environmental measurement devices mounted on equipment poles at various heights and location. The computational system is shown on the edge of the field to indicate positioning either on or off the field is possible. The concept of a ball initial position used as a height and distance reference point is presented as one potential implementation. Additionally, the figure shows the potential utilization of structures already in place, such as range distance signs, to mount some of the invention equipments.

FIG. 2 depicts a potential method for the initialization of the invention's equipment following installation in preparation for using the invention. It shows a sample of the heights and distances that will be measured to provide the information needed to provide the 3-dimensional distance relationships between various measurement equipments and from the height/distance reference point.

FIG. 3 depicts two of the potential grid reference system that could be used in the calculation and manipulation of the distances used within the invention.

FIG. 4 introduces the concept of the inventions application across a terrain that is not flat. It shows a potential field, with the representative and sample equipments depicted in FIG. 1 as they may be deployed on such a non-level field. The various terrain levels along the field are shown in the exploded side view shown in the figure. In addition, a possible grid coordinate system that could be used as a reference for ball position and height is shown as it applies to a non-level field.

FIG. 5 presents the same non-level field and introduces a potential method for using the system to establish and measure the ground height relative to the height reference point at various points across the non-level field. This shows a potential method for the initialization of the invention in relation to the topography of the field prior to its use.

FIG. 6 shows a sample illustration of the method for calculating the ball position while the ball is in flight/motion using the invention's equipment. It shows the concept of using standard triangulation techniques based on time difference of transmission and receipt from any combination of the invention's transmitters, receivers and/or transceivers.

FIG. 7 develops the concept of calculation of the ball height in relation to both the impact of the non-level field and, additionally, with respect solely to the action of the player. This capability represents a combination of functions and concepts previously depicted in FIGS. 3, 5 and 6.

FIG. 8 provides an example display of the wind speed across and above the field as measured and derived by the invention. It shows the wind speed contours developed from the environmental measurement stations and the embedded algorithms in the computational system. Another environmental contour map would show wind speed versus height.

FIG. 9 provides a schematic example of using the invention's equipment to obtain the required information for calculation of Ball Shot Parameters. It shows the development of the spin rate based on the differences in received signal parameters such as amplitude, Doppler and phase at different locations based on transmitted signals of known characteristics.

FIG. 10 provides one set of sample output products and displays of the invention. It shows representative measured and statistically derived flight path data for a number of golf shots in both tabular and graphical form. This level of information is invaluable to the player and the instructor in the performance of the sport and is only available when the detailed measurements obtained using this invention.

FIG. 11 provides an example analysis and output product for the comparison of the results attained by three players each of whom executed the same sports action. A sample data set and presentation graphic is presented.

FIG. 12 provides an example output product with respect to sets of player performance, environmental data and ball motion data observed, measured and calculated at different practice sessions. It shows a set of potential data uses and manipulation techniques to provide valuable data to the player and the instructor across multiple events and for different environmental conditions.

### DETAILED DESCRIPTION OF THE INVENTION

The following description is provided as an example of how the invention could be used by someone skilled in the art of sport activity, instruction, or entertainment. The invention is designed for use in almost any ‘ball’ sports, with only the specifics of the implementation differing based on the requirements and needs of each sport type. In order to present a meaningful and concise detailed description one sport is selected for use as an example of the preferred embodiment and the details of the envisioned invention will be presented primarily in the context of that sport. This is not intended, nor should it, preclude the application of the principles described herein to any other sport.

The sport selected for use in this description is golf. This sport was selected for a number of reasons. The selection of golf as the example sport includes the fact that golf utilizes one of the smallest “balls” or ‘sport objects’, the golf ball travels at the one of the fastest ‘speeds’ of most common sports and specific information such as the ‘spin’ of a golf ball is critical to the playing of the sport. The following embodiments are only one example of how the invention can be configured and employed through the application of the principles described in this illustrative example by persons skilled in the art of the sport and may be embodied in many different forms for both golf and other sport application and should not be considered as limited to the embodiments detailed herein.

The invention described herein is an integrated sports ball and player performance assessment and evaluation system designed to provide a number of layers of performance data relative to a player's action performed on a sports ball and the resultant movement, motion and/or flight of the ball. The invention uses measured and calculated real-time or near-real-time ball-location data to generate the actual point by point track of the golf ball when struck by a golfer. The ball-location data is used as inputs to Newtonian algorithms and to known track generation algorithms, such as a Kalman filter, to calculate the ball's travel-path or trajectory. This travel-path information can be used in a number of ways. For example, the travel-path can be used as a simple display of the ball's flight travel-path for informational or entertainment purposes. It may also be used for detailed analysis of the cause and effect relationship between the player's action, other impacting factors, and the resultant ball travel-path, motions, and characteristics observed.

Statistics on the basic performance values of the travel-path of the ball relative to all relevant parameters either affecting or determining the flight path are used to develop a cause-effect relationship analysis. The factors to be included in the analysis will vary with the sport and even with the intent of the analysis within a single sport. For golf, such factors as the player's current level of experience as indicated by the player's handicap index or other suitable measure, the club used by the player, a specific swing technique employed and other similar factors are reasonable for inclusion in the factors considered during the analysis. Other factors to be measured or collected for consideration in the analysis can be determined by participants skilled in the art of the sport and/or instruction and/or observers desiring entertainment. In addition, local in situ environmental data affecting the trajectory of the ball's travel-path will be measured on the golf driving range or golf course and/or will be obtained from standard models and/or a combination of environmental measurements and models.

The analysis algorithms in the invention may be used in measuring, relating or describing all relevant factors determining the circumstances under which the player action was made to initiate the observed flight travel-path and relate these factors to the actual, measured flight travel-path that results. This process can be performed for a single or any reasonable combination of multiple ‘strikes’ of the ball. The strikes can be performed during a single practice session, multiple practice sessions, during differing conditions or repeated plays of the same genre during the course of normal play.

Another application of the proposed invention is to extrapolate or infer the expected flight-path of the ball for a different set of actuating environmental circumstances than those observed. This is accomplished using the environmental data and observed motion characteristics to calculate, model and/or infer a ball trajectory travel-path negating the in situ environmental effects relating to the player's action or actions on the ball that initiated the flight travel-path observed. Once this is done, the desired different environmental circumstances can be applied and using modeling and/or other similar techniques, the projected flight path and/or motion can be extrapolated and/or derived.

Basic Equipment:

The basic equipments required to provide the elementary capability of the invention are four items:
(1) ball locating system;
(2) in situ environmental data collecting system;
(3) ball-orientation characteristics determination system; and
(4) computational-system that controls, processes, uses, and transmits data to/from items (1), (2), and (3) and displays/outputs products into/out from item (4) and/or other external devices.

The item (1), a ball location system, consists of three elements: (A-1) RF transmitting energy system(s); (B-1) receiver(s)/transceiver(s) to capture the RF transmitted signal and golf ball RF signal; and (C-1) if necessary, a modified golf ball to reflect and/or re-radiated a RF signal.

Element (A-1) of the ball locating system, item (1), can consist of either (i-1) radar equipment or (ii-1) RF pulsed transmitters and receivers or a combination of both types of equipments:
(i-1) Radar equipments: A 3-dimentional (3-D) high resolution radar could provide the 3-D ball-location data required for generating the ball's travel-path. Currently only expensive and/or proprietary government radars are available to perform this function in the manner required to meet the requirements of this invention. Until suitable 3-D commercial radar equipment becomes available, the 3-D function requirements can be accomplished by making modifications to existing commercial or custom built maritime and/or other types of radars. As an example, modifications to two commercial maritime radars can be made to provide short-range, high-resolution, high pulse-repetition-rates parameters that provide the capability to track small sized object(s) at short ranges and special circuits to provide the data required for the ball-orientation and motion characteristics determination system, item (3). A pair of radars would be required to operate together such that one radar unit provides azimuthal bearing and range ball-location data to the computational-system, item (4), and a nearly identical radar unit with slight modifications, such that the unit operates at a 90° rotation on its side relative to the first unit, to provide elevation-angle and elevation-range to the computational-system, item (4). The required ball-location data and ball-orientation data on the golf ball would be the driving parameters for specifying the radar parameter characteristic modifications necessary to the commercial radar units. Additionally, the two radar units would have to be modified to provide synchronization to avoid RF interference with each other and to generate a usable location output data format for the computational-system, item (4). The radar output data is used by the computational-system, item (4), as sequential position input data to be used as Newtonian 3-dimentional (3-D) location input data to a tracking algorithm such as a Kalman filter or other standard tracking or track generation algorithms for calculating the flight travel-path of the ball.
(ii-1) RF pulsed-transmitter(s): A potentially lower cost method, albeit more complicated method, would use widely available omni and/or beamed RF pulsed-transmitter(s) to direct energy on the ball before and during the period of its movement along its travel-path. The specific characteristics and placement of the RF transmitter(s) is determined by the physical layout and the RF background nature of the playing field.

Element (B-1) of the ball locating system, item (1), receiver(s)/transceiver(s) capture the RF signals from the transmitter(s), element (A-1) of the ball location system, item (1), and, if necessary, the modified ball, element (C-1) of the ball locating system, item (1), to provide the data and/or signals required by the computational-system, item (4). The computational system is used to measure, input and/or calculate the ball-location data. The radar source option is designed to have a collocated receiver with the transmitters, element (A-1, i-1) of the ball locating system, item (1), while for the RF pulsed-transmitter(s), element (A-1, ii-1) the option of a collocated receiver is optional.

The specific characteristics and placement of the RF receiver(s), element (B-1), will depend on the location, power and number of transmitters, the reflectivity of the ball and the in situ RF background noise limits allowing the capture of usable signals. In some cases, the invention may require a set of transceivers on or near the field of play to obtain the RF energy level because of the limited receiver sensitivity needed to obtain usable signals. The characteristics of the received RF signals such as time of transmission and receipt, amplitude and/or Doppler and/or phase data are input to the computational-system, item (4), for standard time differential triangulation analysis to obtain ball-location data. This data is used by the computational-system, item (4), as sequential position input data to be used for calculating the Newtonian 3-dimentional (3-D) ball-location data of the ball for input to a tracking algorithm such as a Kalman filter or other standard tracking algorithm to determine the ball location in 3-D space for obtaining a flight travel-path. The data is also used in the in the ball-orientation characteristics determination system, item (3), to determine ball-orientation characteristics. For obtaining ball-orientation input data using radars, there may be a need to provide one or more receiver(s) at locations on or near the playing field separate from the location of the radars location(s). For obtaining ball-orientation data, item (3) using RF pulsed-transmitter(s) at least two receivers will be needed to obtain the data required for calculation of ball-orientation characteristics.

Element (C-1) of the ball locating system, item (1), if necessary, a modified golf ball is used to reflect and/or re-radiated the transmitted RF signal. It should be noted that for tracking and determination of the location points of the flight travel-path there may not be a requirement for any modifications to a sport ball. Depending on the radar cross section (RCS) of the ball, the in situ RF background on the field of play, and the number and position of the receivers, transmitters and/or transceivers most sport balls can be tracked without any modifications to the ball. However using currently available radars or the RF pulse technology previously described may require either a reflective coating on/in the ball and/or a RF device and/or physical modifications to the ball's surface and/or subsurface in the ball in order to obtain ball-location data. Current radars used in sports only provide Doppler information for speed determination.

The modification required to meet invention's requirements can take several forms depending on the type of RF transmitter equipment used:
(i) The system using the radar equipment, (i-1), requires sufficient reflected energy from the ball to be detected and recognized by the radar receiving and processing circuitry. The exact reflective power characteristics of the ball that is needed depends on a number of factors including the size of the field of play in the sport, the radar power output, frequency, environmental conditions and other system characteristics. A reflective-layer in/on a ball or a liquid-coating on a ball may provide enough radar-cross-section (RCS) to provide a usable signal and meet the requirements of the invention. If not, then other RCS enhancements for the ball and/or secondary receivers can be located on the golf course or driving-range to provide the signal-to-noise necessary to obtain ball-location data and/or signals for calculating ball-orientation data. In some cases, a modified ball as described in the following paragraph provides the details for modifications may be required for a ball.
(ii) The option using omni and/or beamed RF pulsed-transmitter(s)/receiver(s), (ii-1), may require a higher re-radiation signal than is provided by the RCS of a ball or the RCS of a ball with a reflective-layer or a liquid-coating. If a higher re-radiation signal is required, passive devices, not requiring an embedded energy source consisting of electronic circuits and/or structural corner-reflectors may be embedded into the ball to provide higher re-radiated signals.

Design and development of the devices for golf balls detailed in element ((C-1) of the ball locating system, item (1), for both RF energy source equipments are presently available as current electronic state-of-the-art capability. Current golf ball construction and state-of-the-art manufacturing techniques would permit the modification to be constructed, albeit some are more expensive than others. Regardless of the system employed and the method used to provide the required reflected signal strength, any modification to the ball will be such that it does not change the normal or required physical response characteristics of the ball as stipulated by the rules of the game or requirements of the sport. Nor will such modifications impact the motion or flight characteristics of the ball beyond the normal variations accepted during normal manufacturing processes of unmodified balls.

The in situ environmental data collecting system, item (2), consists of one or more direct or indirect environmental measurement or observation instruments or systems to provide measured in situ data for critical environmental parameters that affect the ball's travel-path. For the sport of golf, in situ short-term temporal environmental data can have a significant and critical impact on the travel-path of most golf shots. The data and measurements of interest consist primarily of meteorological data which can vary in the 3-D space/time continuum. Another category of critical environmental data is long-term temporal data such as grass length, wetness, ground hardness, etc which can be directly measured and/or estimated by expert observation or historic data. Other data, measurements, and observations that are relevant to this invention can be identified by those skilled in the art of the sport.

The in situ environmental measured data is delivered in near-real time to the computational-system, item (4). The in situ environmental information collected, measured or observed is time stamped to establish a relationship between the data from the environmental instruments and a specific event, such as ball flight observation or other action. There are available state-of-the-art meteorological instruments to fulfill the short-term temporal needs of this invention. There are civil-engineering instruments available to fulfill the long-term temporal needs of this invention.

A ball-orientation determination system, item (3), consists of a confluence of specifications of item (1) and item (2) elements so that higher order characteristics of the RF transmission and ball generated signals can be used to determine the ball-orientation characteristics or ‘spin’ of the ball around all axes of rotation. Current state-of-the-art electronic circuits can process the received RF signal for determination of signal amplitude changes, Doppler changes, phase shifts and other signal characteristics that can be used to calculate ball-orientation characteristics such as spin during the travel-path of the ball. The specific equipments required to establish the ability to perform this function have been previously identified for RF modifications to a ball. For an unmodified ball certain physical modifications on the ball such as the laces on a football or the stitching on a baseball may provide changes to received signal parameters for determining ‘spin’ data. For completely symmetrical balls, subtle physical modification may be implemented on the surface and/or subsurface to provide signal parameter changes that can be used to obtain spin and/or enhance the RCS.

A computational-system, item (4), consists of two elements. These elements are: (A-4) a general purpose computer and/or custom computational device(s) and (B-4) the associated connections to the other three equipment items. The computational-system's, item (4), functions are to:
(i-4) control the operation of all system functions and equipments including the input of data, interface with the user(s) to establish desired operating modes, output of desired products and the coordination of all system elements and other command and control functions as required for the proper operation and functioning of the invention
(ii-4) coordinate handling, receipt, store, and manipulate the transmission of RF energy and receiving the RF energy signal data from the ball locating system, item (1), and the ball-orientation system, item (3);
(iii-4) use the data from the ball locating system, item (1), to calculate the ball's travel-path using Newtonian physics, standard tracking algorithms, and standard state-of-the art triangulation algorithms;
(iv-4) receive, store, and manipulate the environmental data from the in situ environmental data collecting system, item (2), and topography contouring algorithm, then merge it with modeled environmental data, if necessary, and/or substitute modeled environmental data;
(v-4) receive, store and manipulate the data from the ball-orientation characteristics determination system, item (3), and calculate ball-orientation characteristics.
(vi-4) calculate, model and/or infer a virtual ball travel-path that uses the environmental data to remove the local in situ environmental effects from the original ball's travel-path and calculate the expected travel-path without these condition(s) and/or under other specified condition(s);
(vii-4) perform statistical analysis, store results and generate output products with respect to the cause and effect relationship between the circumstances of the player's actions, the environmental measurements and observations and the resultant observed flight path and motion characteristics of the ball; and
(viii-4) control the presentation and display of data and products using state-of-the-art and/or advanced display techniques and processes and other devices including recording and/or broadcast and/or world wide web and/or film and/or other media systems.

Example Equipment Layout and System Initialization for Golf Driving-Range

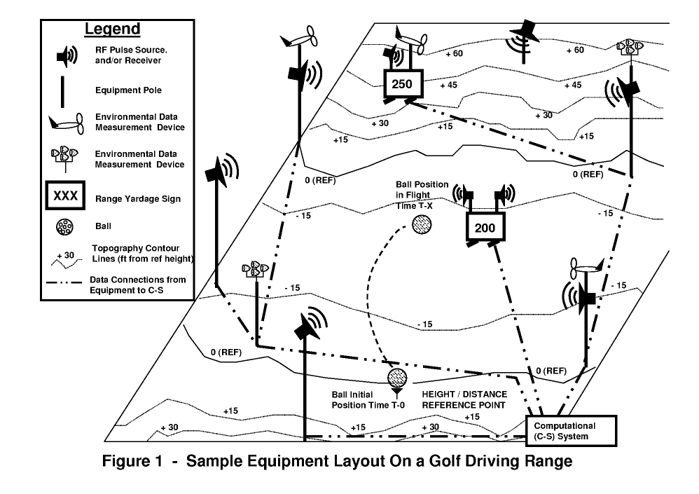

An example layout of the invention's basic equipment elements using the RF pulsed-transmitter(s), element/type (A-1, ii-1), energy source option on a golf driving range is provided in FIG. 1. The legend of the symbols identifies the hardware on and near the driving range. On the driving range are the normal distance-markers identified as Range Yardage Sign (representative of structures already existing on the field) each with one or more transmitter, receiver, transceiver boxes containing a ball locating system, item (1), an in situ environmental data collecting system, item (2), and the equipment and ball-orientation characteristics determination system, item (3), equipments. In addition, attached to equipment poles additional transmitter, receiver, transceiver boxes are positioned for ball locating system, item (1), and ball-orientation characteristics determination system, item (3), equipments. Meteorological Instruments are located on equipment poles at positions representing the in situ environmental data collecting system, item (2), equipments. The ball, at rest at the initial/reference position ready to be struck by a golfer, is a modified ball specified in the ball locating system, item (1), as element (B-1) of the invention Basic Equipment List. During the initialization period, the invention will be used to establish the location, either a small area or specific point, where the player will initiate the action on the ball and from which the ball travel-path will begin. This initialization will aid in the tracking algorithms and in determination of the ball being observed or in play. This location or point will be recognized in the computational-system, item (4), and will be used in system computations. The ball at position in flight at ‘T-x’ is the same ball at a time during flight after being struck. The last piece of equipment shown on the figure is the computational-system, item (4), specified in the Basic Equipment list of the invention. While the computational-system, item (4), is shown on or near the golf driving range, it can also be positioned at a remote location and connected by a physical connection or wireless means.

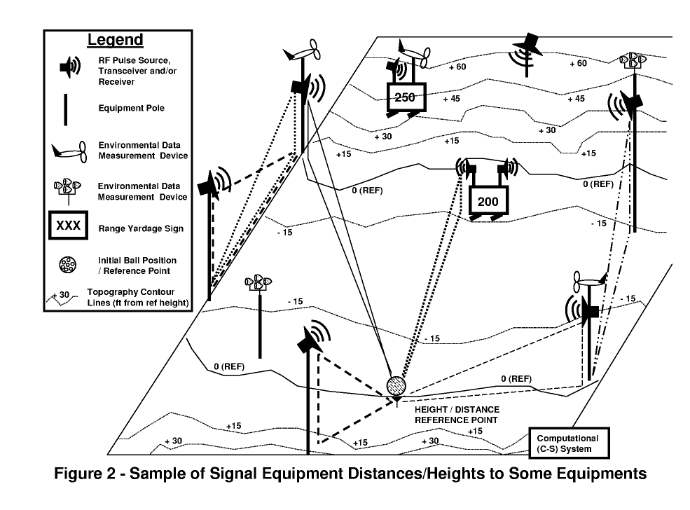

FIG. 2 schematically shows a potential method for the site initialization of the invention with respect to transmitter(s), receiver(s), transceiver(s) and in situ environmental instrument locations. The distances and heights of each transmitter, receiver and/or transceiver and environmental instrument location are calculated and/or measured independently by mechanical and/or other means during the equipment installation on the driving range. The RF travel time is theoretically computed in the computational-system, item 4, by means of standard physics formulae and is used in the initialization-test phase to verify that the invention equipments are ready for operation. The verification of the measurements and system operability is a comparison of the distance generated by RF test-pulse results to the independently measured distances. This process will be repeated periodically during actual system use to insure that the system is operating correctly.

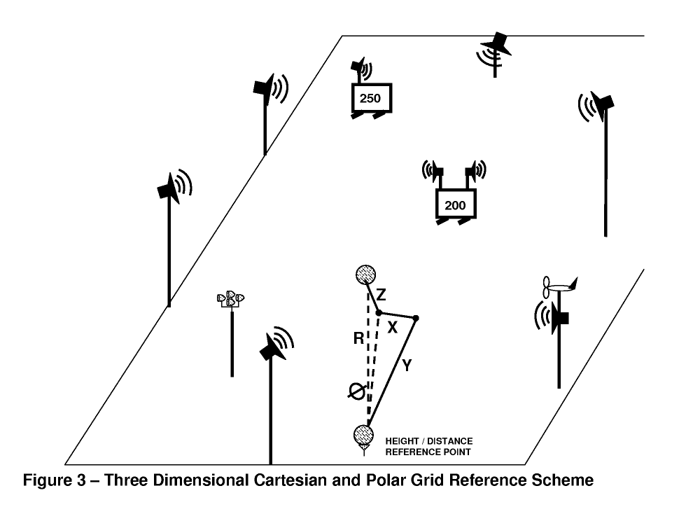

FIG. 3 provides an example of 3-dimenaional grid systems that might be used to describe the position of the ball in flight in relation to the height/distance reference point established in the system.

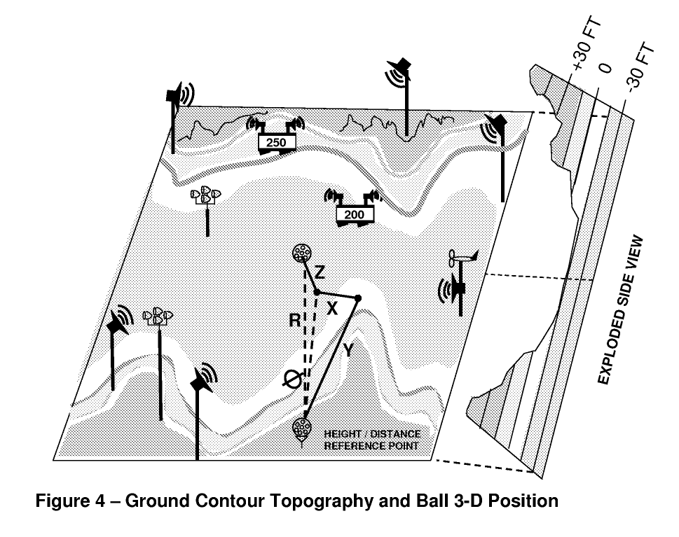

FIG. 4 depicts the potential impact of a non-level field on the functioning of the system. The determination of the topography of the driving range is critical for accurately determining ball-location data. If the topography of the driving range is not flat, the invention will use an algorithm that provides a virtual characterization and mapping of the basic topography of the ‘field’ for use within the system. Contoured topography data is a requirement for accurate performance locating data so that a valid ball travel-path can be calculated and used for determining launch angle, apogee, speed, number of bounces, flight distance, bounce distance, and total distance and to identify topographical features that may have impacted these factors.

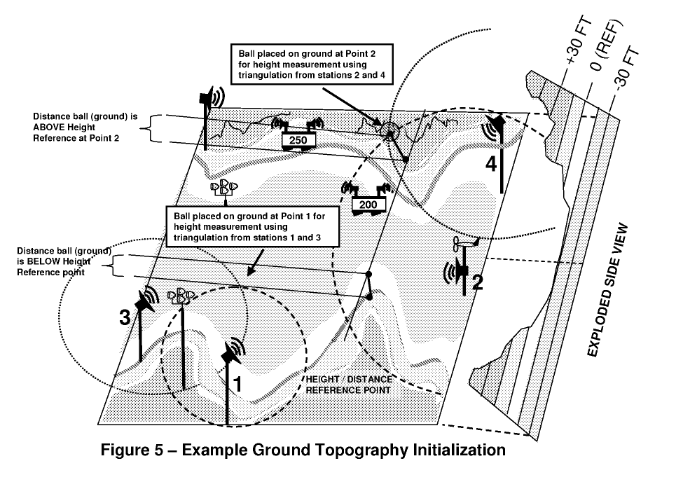

FIG. 5 presents a method for the initialization of the invention with respect to the topography of the field or driving range. The distances and heights of all the transceiver equipments and the meteorological instruments will be used as inputs to the topography algorithm used for calculating the ball-location data. All of the equipment positions and heights and the initial ball position and height relative to a range reference-point will be used in the topography calculation algorithm contained in the computational-system, item (4).

If the golf driving range or golf course being used has a previously defined and/or determined topographic height reference-point data, the position/height data for each reference point would be input into the computational-system, item (4). This data will use used as input for a contouring algorithm that provides the contour heights/positions across the entire field or practice area. The topography contouring algorithm uses these position/height data to establish a contour map of the desired portion of the driving range and a height-reference point for the ball locating calculations algorithm.

If the golf driving range or golf course being used does not have previously defined and/or determined topographic height reference-point data and is not flat, the contouring algorithm will be used to determine the contour of the specific area of the driving range. A modified golf ball(s) can be placed at appropriate high and low spots on the playing field for critical or significant ‘high’ and ‘low’ points or in a grid pattern across the desired field of play to determine the height of that location relative to the reference position. Using this data, a contouring algorithm is used to provide the height and position of each spot. The topography contouring algorithm would use these position/height data to establish a contour map of the desired portion of the driving range and a height-reference point for the ball locating calculations algorithm.

Computing Travel-Path of the Ball

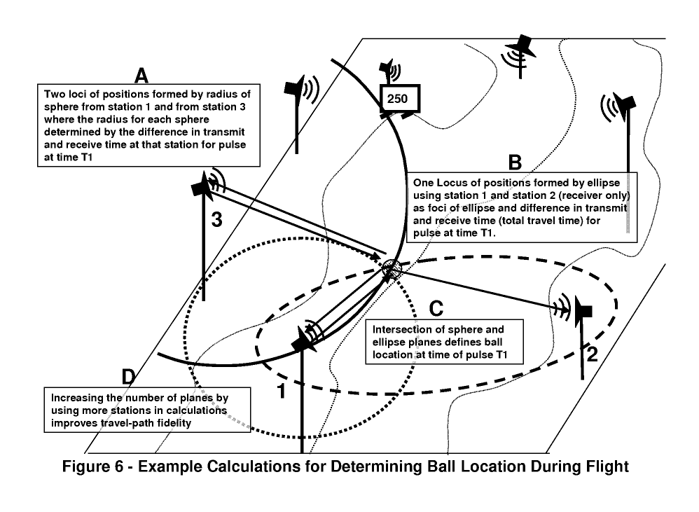

A sample illustration of the method for the calculation of the ball location is shown in FIG. 6. It represents the use of the RF pulsed-transmitter(s) and receiver(s) method and shows all the possible signal travel-paths between the transmitter, receivers and/or transceivers when each transmitter and/or transceiver transmits a pulse of RF energy. This figure shows a representative set of algebraic distances and angles which could be used in mathematical calculation of one ball location based on time-received-differential-triangulation obtained from a RF pulsed-transmission on a golf driving range or golf course.

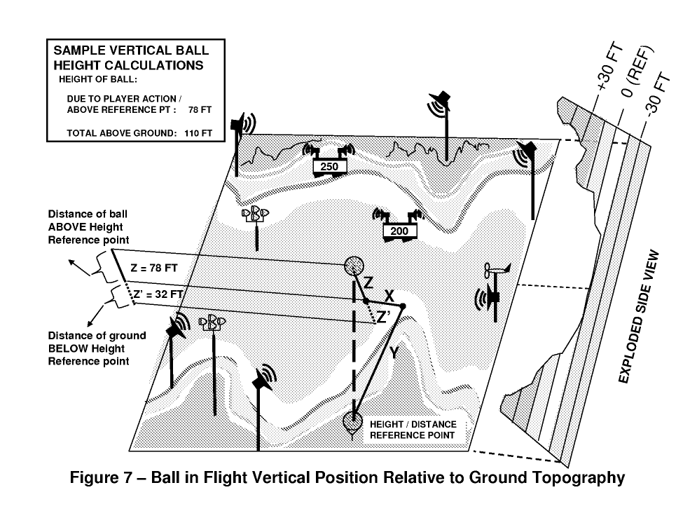

The specifics of the method to be employed in computing the travel-path of the ball is dependent on the specific three dimensional (3-D) physical positioning and functioning of the ball locating system, item (1), equipments and other considerations such as the size and topography of the field and other physical factors as well as requirements of the sport being observed. An example of the inclusion of the topographic considerations of a non-level field is shown in FIG. 7.

The explicit positioning and functioning of the transmitters, receivers and/or transceivers, the mathematical triangulation calculations and the track generation methodology are well known in the art and are easily applied by those skilled in this area.

Determination of Ball Being Observed and/or in Play

The ability to distinguish the specific ball that is the object of the current observation and/or in play from other balls used by the invention that are not the subject of the current observation is accomplished by differentiation in the physical characteristics of the ball in play as compared to all other balls. Prior to being struck, the system will make this determination based on the location of the ball by analysis of the RF signals. For the golf driving range example, this will be based on the position of the tee as the start/reference point established at the initialization of the system. For a ball being struck, this differentiation is achieved by a number of methods including using parameters such as a Doppler effect frequency translation of the received RF signal at the receiver and/or different frequency bands for each ball and/or lack of change of position as a function of time and/or similar factors and/or other information. This determination will be made within the computational-system, item (4), which will use this information to control system observations and limit the system to focus only on the ball currently being observed or in play. The determination of the ball in play is easily accomplished using the equipments and information disclosed in other sections of this invention by anyone skilled in the art.

In Situ Environmental Characterization using Measurements, Algorithms and/or Models

The ability to characterize the environment across the field of play or practice area is an important aspect of the invention's analysis function. The environmental measurements, algorithms, and models comprise three different elements that may be used independently or in combination with each other to accomplish this characterization; plus a topographic contouring algorithm which is discussed in a separate section.

The in situ measurement instrument(s) provide real-time and/or near-real-time measured data and/or historic data concerning the relevant environmental factors at points across the field/practice area. The environmental measurements are real-time or near-real-time and are comprised of continuous measurements and/or periodic measurements made before, during, and/or after the sports game or period of observation. Historic data consists of the best available data recorded from previous measurements, research, historical data, analysis and/or the like. This capability is identified as the in situ environmental data collecting system, item (2).

Possible implementations of environmental characterization made on the golf driving range include:
(A-2) Real-time measurements taken during the observation using meteorological instruments on an equipment pole on the driving range/golf course that measures and transmits factors such as wind speed, wind direction, temperature, humidity and/or other pertinent parameters to the computational-system, item (4), on a continuous or near-continuous basis. A simpler implementation of this capability consists of data from similar instruments that is manually entered into the computational-system, item (4), before and/or during and/or after the practice/observation session and/or;
(B-2) Non-real-time environmental measurements/data entry might consist of soil hardness, grass type, grass length, ground wetness, etc. environmental measurements made before, and, if necessary, during and/or after the practice/observation session that are automatically and/or manually entered into the computational-system, item (4), equipment and/or;
(C-2) Modeled and/or historic environmental data that is used in lieu of measured data when obtaining measured data is not practical or measured data is not available and/or to supplement measured data when required to assist in and/or permit environmental characterization. This data may be extracted solely from modeled and/or historic data based information and/or data based on a combination of historic data and/or in situ measurements and/or modeled data. An example of this would be historic soil hardness data based on a previous soil sample characterization and modeled grass wetness based on observed temperature and humidity measurements. This information is provided to, contained in and/or generated by the computational-system, item (4) and/or;
(D-2) Algorithms that provide information for environmental characterization in 3-dimentional space across the entire field by manipulating, interpolating, extrapolating and/or contouring the data measured at specific points. In this example, the algorithms would be used to extrapolate the real time measured data described above, averaging as meteorologically and physically appropriate for each measurement set and contouring these factors between the measured points. This manipulation and contouring function would continue for the duration of the observation period at appropriate intervals. The algorithm would perform a one time contouring of historic information with respect to soil hardness across the field and periodic contouring of the modeled grass wetness for the duration of the observation period and/or;
(E-2) Any combination of these examples and/or another method known to the art.

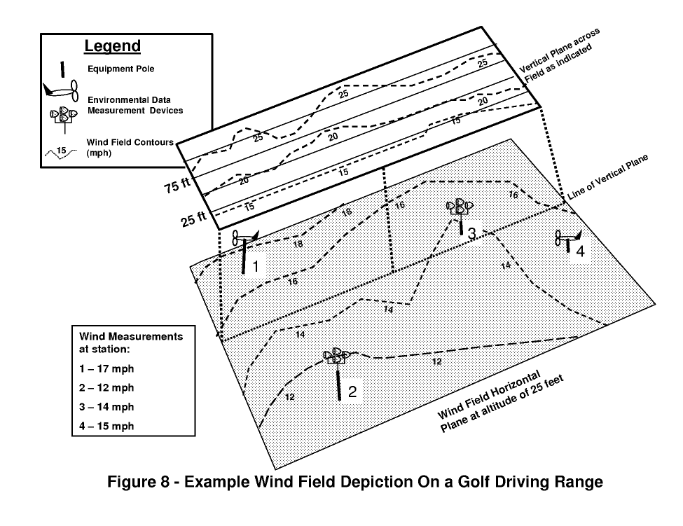

FIG. 8 presents an example of the product that may result from the process described above. In this illustrative case, wind measurements from four stations are used as inputs to a contouring algorithm that produces a 3-dimensional wind field across the field. The number of stations and the fidelity of the resulting contours would be determined by the specific application being implemented.

Determination and Calculation of Ball Shot Parameters

The determination of the shot parameter characteristics is accomplished primarily by the computational-system, item (4) in the Basic Equipment List, that manipulates the data obtained and received from the ball locating system, item (1), and through the calculations performed in the ball-orientation characteristics determination system, item (3). Accurate ball locating data based on the Newtonian mathematical calculations and tracking filter(s) and/or other algorithms to determine the ball's 3-D travel-path have been previously described. These are used for determining critical and informative performance values which for the golf example includes factors such as launch angle, apogee, ball speed, number of bounces, flight distance, bounce and/or roll distance, and total distance. All of these and the other applicable factors are calculated both overall and at various points and/or times in the ball flight and/or motion.

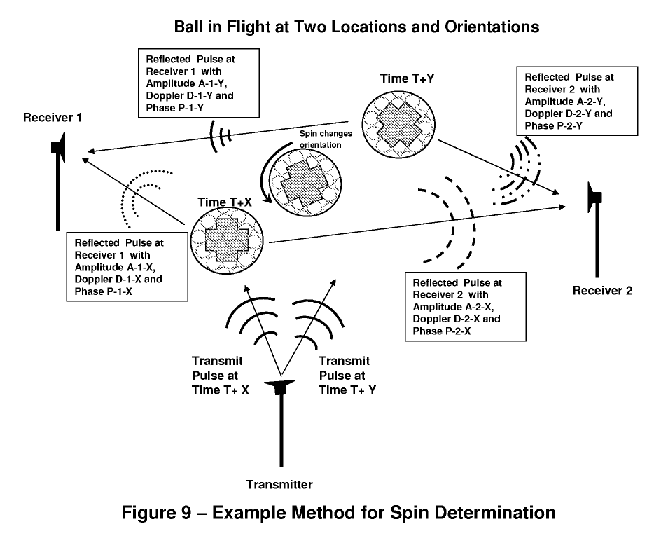

The determination of ball-orientation characteristics may require the use of special processing of received RF signal data from the ball locating system, item (1), into the ball-orientation characteristics determination system, item (3). The algorithms and calculations are performed within the computational-system, item (4). An example calculation is shown in FIG. 9 which provides a schematic example of two receivers obtaining signal amplitude, Doppler, and phase data at two different locations for comparison to the known transmitted signal characteristics from a single transmitter. The number of transmitters and/or receivers required to perform this function will be dictated by the size of the field and the precision desired in the motion characteristic calculations. The computational-system, item (4), contains ball-orientation characteristic determination algorithms which uses this data to determine ball-orientation characteristics at different locations along the ball travel-path. The signal processing algorithms to be applied in this calculation are well known and established in the art and are easily employed by persons skilled in this area to determine the desired results.

Conducting Cause and Effect Analysis and Statistics Generation Relative to Player Action and Circumstances, Environment Conditions and Resultant Ball Flight

The analysis and evaluation/establishment of the cause and effect relationship between the player's actions and circumstances, the environmental conditions, and the resultant ball motion and travel-path is the underlying and primary purpose of the invention. Generation of this analysis and the resulting statistics is provided by the computational-system, item (4), using its capability to capture, to store and to manipulate the input and calculated data from the other invention's systems equipments. The computational-system, item (4), uses this data, standard statistical algorithms and custom routines and applicable algorithms tailored to the requirements of the sport, the characteristics and/or factors being evaluated, and the output display needs of the user and/or audience.

Continuing the golf example, a likely utilization of the product generation component of the invention is on a golf driving range. A typical employment envisioned is a series of shots which are statistically analyzed using appropriate statistical algorithms in the computational-system, item (4), to provide 1^{st} and 2^{nd} and higher order statistics on the selected shot series' performance values relating to launch angle, apogee, ball speed, ball-orientation at different segments of the travel-path, number of bounces, flight distance, bounce distance, distance left/right from intended path, distance from a specified target, total distance, and/or other performance values. Reference information concerning the player's action and circumstances include the specific club used by the player and a particular swing technique employed. Finally, the environmental conditions, such as wind speed and direction along the ball's flight path, that are present at the time of the shot is recorded and analyzed for potential impact on performance.

All of this information is combined to produce a number useful outputs and/or products. The first product might be information with respect to the distance the ball flies in the air and how far the ball rolls out after hitting the ground for a specific club. This information is useful in the actual performance of the game by providing the player with a basis for club selection at different locations and/or conditions on the course. Another use might be for a golfer to strike a series of balls with one technique and then striking a second series of balls with a swing adjustment to the initial technique or with a different club to determine the difference this makes in the ball travel-path results. Another application is an analysis where the current ball flight result could be compared to the ball flight path results observed in similar circumstances and/or compared to the flight path results with some conditions the same and others changed to determine the actual impact of the changed factors. Another potential use of this statistical data set is comparison of this data set to a past or future data sets as reference point for instructional improvement. Even the travel-path of a putted golf ball on a green could be compared to a straight or curved reference-line for instructional benefit or audience enjoyment. Another analysis focus and product output could be to compare the results of two or more players for the same or similar game or practice circumstances. Many other factor combinations for analysis, statistics generated from them, and the uses thereof could be postulated and easily developed by someone skilled in the game and/or an instructor of the game and/or for presentation to viewers for understanding and enjoyment of a sport.

System Output Products and Output Display

The invention has the capability for the output of a number of products which provides significant benefits to a player and/or instructor and/or viewer with respect to the measured data, the calculated information, and the analysis results. There are many levels of information presented with the specific level determined by the type of user and their purpose for using the invention. The viewer may use the products simply for entertainment and/or interest in the exploits of a particular player. In this case, the output products and displays envisioned might be at a lower level of fidelity and represent a less rigorous manipulation and analysis. For a player, the level of fidelity and analysis will be raised to provide analysis and outputs geared to provide more detailed and in depth analysis results. This analysis may include a more meticulous and wider ranging input and use of the data, increasing the depth of analysis to provide a larger and more varied range of products from which to choose and producing a more advanced and/or refined display format. The analyses results could be provided to a viewing audience to demonstrate the differences between two or more players.

The results generated by the computational-system, item (4), could be displayed and used on any display surface and/or output device connected to and controlled by the computational-system, item (4), and/or provided to a display device at a remote location for small audience viewing or provided to a broadcast and/or world wide web and/or film and/or other media sources. The format, fidelity, resolution and content of the display of output of data, products, statistical analysis results and/or any combination of these parameters depends on the intended audience for the output selected.

For the golf driving range example, one of the expected outputs is a visual graphical 3-D overlay of a series of golf shots for a player using the same club showing the player and/or the instructor the information described in the previous paragraph and/or other analysis results. Visual presentation of the ball flight trajectories of the shots comprising this set of data could highlight whether the player has a consistent result which would provide visual re-enforcement for maintaining a consistent stroke.

The display of data, information and analysis results can be combined using appropriate display techniques such as graphical, tabular or any other selectable format. For a broadcast and/or World Wide Web and/or film and/or other media audience(s) a graphical presentation of the visual graphical 3-D overlaid on a video replay of a golf shot could add audience enjoyment to the broadcast and/or World Wide Web and/or film and/or other media. Another feature for broadcast and/or web and/or film and/or other media would be to provide visual graphical 3-D overlays of several different players' ball-travel-paths to illustrate the differences among players' performances and/or comparison of the actual shot performance values for each player's shot on a specific section of the golf course.

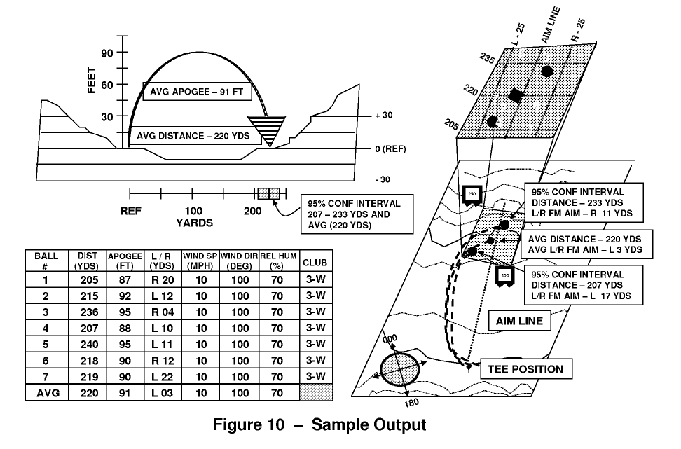

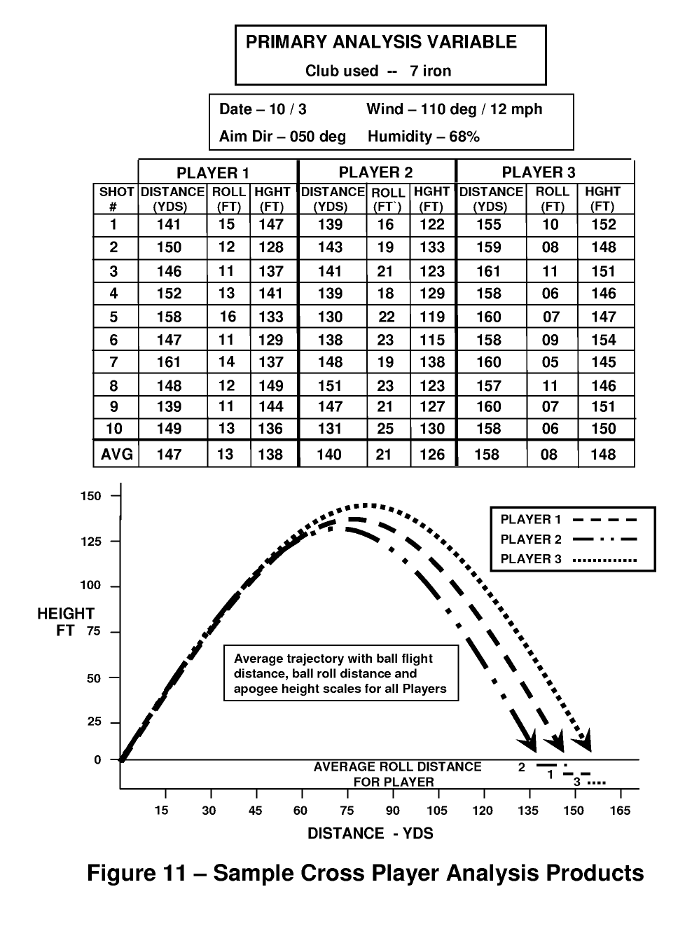

A number of example output products are provided in FIGS. 10 and 11. These examples represent a small percentage of the possible products that can be developed and are, therefore, presented as only being illustrative of the range of outputs contemplated for the invention. FIG. 10 shows the results of the measurement of seven golf shots (any number may be chosen) made by one player during a practice session. The information focused on in this example is the distances the ball travels down range, the distance right and left of the aim line that the ball lands and the apogee of the ball during flight. Various levels of statistics are derived and presented for the flight distance, distance right or left of aim line direction and the apogee. This information is presented both graphically and in tabular formats. Additionally, in the expanded surface region shown in the geographic representation, the measured location of ball landing for each of the seven shots is shown as represented by the number of the shot. This lower level data is useful to the player as it can be directly equated to the player's perception of performance during each of the individual shots.

Another analysis and output display of interest is the comparison of two or more players showing the results attained when each player executes the same sports action, in this case striking a golf ball using a 7 iron, under the same environmental circumstances. FIG. 11 provides an example of this focus where three players executed a series of 10 golf shots using the same club, in this case a 7 iron. The example parameters of interest in this example are the distance of the ball in flight, the maximum height (apogee) observed in the trajectory and the amount or distance of roll observed after the ball first impacts the ground until it comes to rest. In this example, a perfectly flat field is shown, however, the same parameters could be address in this or other analyses types for a non-level field using the terrain contouring algorithms described in previous sections. This product would be especially useful for presentation to a viewing audience but would have numerous useful applications in other ways.

The range of output and display types and methods include video, modeled output, simulated video, audio, simulated audio, graphical, tabular, a combination of any of these formats and/or any other appropriate state of the art presentation format available or that will become available which will properly and effectively convey the data and/or information to the user or the viewer in a meaningful manner. Other display types and uses of the data and results of the analysis could be determined by those skilled in the art of the sport, broadcast and/or web and/or film and/or other media.

Extrapolation of Observed Ball Flight Path to Other Circumstances

The invention provides the capability to project, to model and/or to infer the expected travel-path of the ball resulting from proposed and/or selected player actions and environmental conditions. These projected travel-path result excursions are based on the observed results and observed circumstances which are mathematically manipulated to produce the expected travel-path of the ball under the defined and different circumstances.

Algorithms designed to extrapolate, to infer and/or to model the basic component factors of the observed ball travel-path based on and/or with a given and specified set of player actions, player circumstances and/or environmental factors is contained in the computational-system, item (4). The measured environmental data, contoured environmental data, historical environmental models of environmental data bases and/or environmental model algorithms contained in the computational-system, item (4), are the basis for the determination of these component values. In this manner, the impact of the observed player's action, and/or player's circumstances and/or environmental factors can be accounted for and the kinetics and physics of the travel-path path observed can be deduced.

These basic travel-path components are identified and defined sufficiently to produce the same observed travel-path results in a kinematics based ball flight model or other appropriate mechanism. Then using the desired changes in player action, player circumstances and/or environmental conditions, these factors are applied to the kinematics of the ball-motion-model and/or other mechanism known in the state of the art that is used to calculate the projected and extrapolated Newtonian 3-dimentional location and travel-path of the ball. As a result, using appropriate models and techniques, the travel-path of the ball with the introduction of other circumstances and/or environmental factors, as desired, can be modeled, determined, calculated, and deduced.

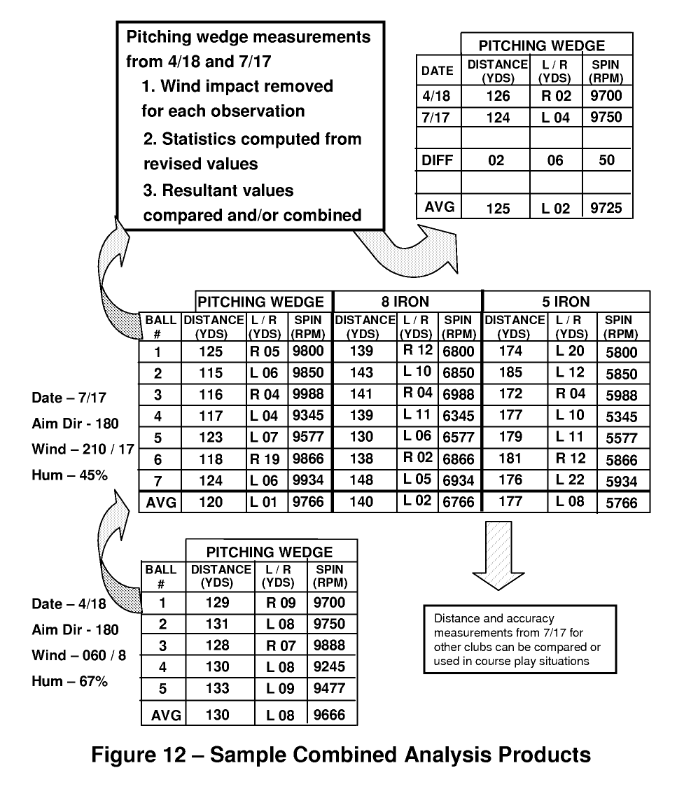

FIG. 12 presents an illustration of the capability of the invention to obtain data across different practice sessions and manipulate that data in a meaningful manner. In this example, the values of distance down range, distance right or left of aim direction and ball spin are obtained in two separate measurement times and for three different golf clubs. In addition, the environmental conditions of wind speed and humidity present during each session is presented. For simplicity, these environmental measurements are provided as a single value. However, in the calculations contemplated, the wind speed and direction contours constructed from the various measurement stations, as shown in FIG. 8, would be used to normalize the observed results for the two different circumstances so they may be more appropriately compared. The normalization process is envisioned to consist of the use of measured data and parameters, such as ball spin, input into an appropriate kinematics model. The output of the model is the normalized result with the factors of interest eliminated so that proper combination of observed values or reasonable comparison between the observations can be accomplished. A similar method using statistical techniques such as Analysis of Variance (ANOVA) could also be applied to determine the critical or most influential factors across the observation sessions. Manipulations and extrapolations such as this provide the player with information of the expected performance under no wind conditions or selected wind conditions in addition to the conditions under which the sessions were conducted.

Ball Collection and Sorting

A likely employment of this invention, especially when used in a practice environment, will result a large number of balls being located on or around the field. If a modified ball is used, it is also to be expected that contained in this assemblage of balls there will be a combination of balls some of which are modified for this invention and some number that are not so modified. The invention includes a capability to collect all of these balls using standard methods and the ability to sort the modified balls that are used in this application from those balls that have not been modified. In addition, the invention will provide the ability to sort modified balls into appropriate groups based on specific characteristics relative to the modification such as those in a specific frequency band, if that characteristic is applied. This capability will allow the sorting to be performed quickly, automatically, and using a combination of factors such as physical ball characteristics, electronically, any other appropriate method and/or any combination of methods.

What is claimed is:

1. The method of an integrated sports performance information, measurement, assessment, and computational system for a sports related player(s) initiated action on a sports ball and the circumstances surrounding that action that utilizes a motion path location tracking capability of a sports ball, if necessary a modified sports ball, for determination of travel path and/or motion characteristics, such as spin, of the ball, the incorporation of the impact of circumstances relevant to the player's action such as in situ environmental conditions and other player related factors and the generation, output and presentation of 1^{st}, 2^{nd} and higher order statistical characterizations of the combination of causal action, surrounding circumstances and resultant ball travel to assess, explain and describe each component and to be used by the player or an instructor to evaluate or improve the player's performance and enhance an observer's understanding and enjoyment of the sport.

2. A method of claim 1 further comprising a number of subsystems and functions designed to empirically determine and measure the location and motion of the sports ball; the measurement, collection, manipulation, analysis and display of relevant data and associated information concerning the sports ball's trajectory, flight path and/or motion of the sports ball, environmental conditions existent at the time of the action and information describing the state and circumstances of the player and associated factors at the time of the action.

3. A method of claim 1, further comprising a ball location and tracking sub-system and function using an electromagnetic radio spectrum with electromagnetic radar/radio frequencies (RF) in the 3 kHz to 300 GHz region as defined in 1996 by the Office of Spectrum Management in the National Telecommunications and Information Administration of the U.S. Department of Commerce with the system consisting of (1) an energy source such as a transmitter(s) in a radar(s) and/or pulsed RF transmitter(s) and/or pulsed RF transceiver(s); (2) if necessary, an RF reflective surface(s) and/or re-radiation device(s) in a modified sports ball, (3) receiver(s) in one or more radar(s), and/or receiver(s) for RF pulsed transmitter(s) and/or receiver(s) in RF pulsed transceiver(s) with any combination of the RF sources and receivers connected using wired or wireless means to a central processing station for the purpose of empirically and continuously or near continuously, determining the complete flight trajectory of the ball on a point by point basis in real time or near real time this being accomplished by empirical measurement through appropriate triangulation and position fixing techniques using the results garnered from the network of transmitters and/or receivers placed on or near the sports playing field/arena/rink, ring, course/court/etc and/or associated practice area such as a golf driving range or equivalent location for the sport of interest.

4. A method of claim 1 further comprising an in situ environmental measurement and sports field contouring sub-system using near real time data, previously measured or determined data, modeling and contouring techniques for determination of the physical and environmental factors in the vicinity of the field which may impact the ball travel path and the utilization of these data in the statistical and other algorithms.

5. A method of claim 1 further comprising a ball orientation and motion parameter characterization (i.e. spin) sub-system that utilizes inputs, data and information from the other sub-systems to computationally determine, model or extrapolate ball flight and motion characteristics, such as spin, using standard and known in the art techniques of received signal characteristics differentiation and processing from various transmitter(s) and receiver(s) combinations.

6. A method of claim 1 further comprising a computational sub-system that controls the functioning of the other sub-systems, serves as an interface and system employment mechanism for the user, collects and stores the data from all sub-systems and data sources, manipulates and conducts operations with or on the data measured or generated by the other sub-systems, performs analysis on the data to generate the 1^{st}, 2^{nd} and higher order statistics as well as other output products and displays and presents the results to the user(s).

7. A method of claim 1 further comprising, if necessary to provide a required signal level of characteristics, a modified ball with a reflective surface(s) and/or an embedded device(s) consisting of a re-radiation device(s), corner reflector(s) or other RF device(s) and/or physical modifications to the ball's surface and/or subsurface wherein these devices respond to the received RF/radar transmitted pulse from the external sensor network at the same or at a pre-defined or designated response frequency; provides a beam-pattern and/or change in signal parameter and, with the ball motion, generates different amplitude and/or Doppler and/or phase and/or other signal parameter changes to the basic RF signal, with the RF signal power resulting from the reflective surface(s) and/or embedded device(s) that may be required in this system application varying depending on the sport application and other factors such as the size of the field, the environment in which the sport is played, etc. and designed such that the embedded device does not alter the physical and response characteristics of the ball such that if two identical forces are applied to two balls, one with the device and one without, under the same conditions, the difference in the response of these balls to standard performance tests will be no greater than the response of two unaltered balls acted upon in the same manner and under the same conditions and each ball with a device embedded will be capable of being distinguished from other balls without the device in an electronic and non-electronic related manner such as special markings, color or the like to permit easy identification between balls with and without devices embedded.

8. A method of claim 1 further comprising the ability, if necessary, to electronically and automatically differentiate a ball in play, either modified or unmodified, (i.e. the object of the observation at the time) from other balls that have previously been used or are waiting to be used in this application and are still on or in the proximity of the playing field using standard techniques known to the art such as observed acceleration vector, velocity, received RF signal Doppler and/or other signal parameter(s), cessation of movement in one or more planes of motion, etc.

9. A method of claim 1 further comprising the ability, if a modified ball is necessary, for collection of the sports balls that is consistent with techniques currently employed in the sport, the ability to automatically sort potentially large numbers of balls by determining and segregating the balls having a reflective surface and/or embedded device for this application from balls that do not have a reflective surface and/or embedded device and the ability to further identify, sort and segregate balls with reflective surface and/or embedded device into logical subsets such as balls with a particular frequency or frequency range to improve or facilitate the ability to re-use these balls in future observation sessions.

10. The method of one or more in situ environmental measurement and monitoring network(s) of instruments that will, be used once, at discrete times and/or continuously or near continuously to, as completely as possible, establish and describe the local environmental conditions that may reasonably be expected to affect the motion and travel of the ball with the instrument(s) and/or network(s) located at varying heights, locations and/or orientations on or near the sport field to establish the relevant environmental conditions such as but not limited to, wind speed and direction, temperature, relative humidity, etc. with the data type collected and/or extrapolated and frequency of observation determined by the specific sport being observed.

11. A method of claim 10 further comprising a capability wherein if there are locations with no direct environmental measurements, the measured data will be extrapolated and/or interpolated to characterize environmental conditions in three dimensions across the entire playing field at the time desired, such as the time of the observation, using standard modeling applications, mathematical contouring techniques and other good practices of meteorologically defined processes and procedure.

12. The method of a computational-subsystem processor or processors, which may be positioned at or near the playing field or a remote location, designed to operate, monitor, and control the functioning of all other system components and sub-systems; receive and store data in relational database(s) or other form; access data in a relational or any appropriate manner; view the data in any appropriate form; perform calculations on and/or manipulate the data; record, edit, output and display data and/or analysis results; if necessary, relay data generated or obtained from any observation and/or resultant output products and/or any sub-system to any other sub-system component, location or user; contain environmental and position tracking algorithms, models, and historical data; and function as an interface between the user, observer, player, viewer, instructor, etc. and the system to establish the specific mode of operation, display, configuration, system trouble shooting, maintenance, etc. that would normally be associated with system operation.

13. A method of claim 12 further comprised of algorithms located in the computational system and/or other processor(s) that will, using the results obtained from the RF network, empirically and continuously or near continuously determine the ball positions for the purpose of recording the flight trajectory of the ball by using the received RF reflected pulse and ball-location data, standard time differential triangulation analysis, Kalman filtering and/or other standard and known position tracking calculation methodologies to calculate the ball travel-path and orientation data.

14. A method of claim 12 further comprising the ability to utilize as input to computational algorithms any other relevant and/or supporting information from any source either currently available in the state of the art or can reasonably be expected to be available including information from equipments and devices such as ball launch monitors, foot pressure measuring devices, swing monitoring equipments, motion sensors, etc.

15. A method of claim 12 further comprising analysis software modules designed to address and calculate specific sport appropriate performance and effectiveness metrics and criteria wherein the primary focus of the analysis is with regard to the resultant reaction of the sports ball (such as flight trajectory, ball-orientation characteristics, distance traveled, ball height versus distance, ball speed versus time, distance to 1^{st}, 2^{nd}, 3^{rd}, etc. bounces, etc.) as caused and/or impacted by the action of the player, the current environmental conditions and player circumstances such as equipment used, etc. with the specific analysis functions utilized determined by user selection, standard designed statistical analysis functions, user stipulated analysis or a combination of all of these criteria wherein each analysis function is capable of being performed on all data, any subset of data, data related to a single event or episode or any number of multiple episodes as appropriate and/or any factors or set of factors that are important to the sport or the analysis being conducted such as chronological time, improvement in performance, use of difference equipment, different environmental conditions, etc.

16. A method of claim 12 further comprising the ability for determination and calculation of all relevant physical properties of the ball for the shot trajectory and motion that are measured, calculated and/or extracted based on the characteristics of the reflected RF pulse data, from the continuous or nearly continuous position of the ball based on the calculation of the travel-path of the ball in 4-dimentions, three spatial planes and temporal, and the orientation of the ball on the travel-path (such as spin, wobble, tumble, launch angle, ball spin rate around all applicable axes, etc.) for use in monitoring, recording, analyzing, and displaying the ball results.

17. A method of claim 12 further comprising methods such that the data obtained by and/or developed by the in situ environmental characterization sub-system is used to calculate, model, project, and display the impact of these parameters on the ball travel-path actually observed and extrapolate based on the observed conditions and results the expected results either without the observed environmental condition(s) or for any selected set of conditions.

18. A method of claim 12 further comprising the output of analysis results in the form of relevant and sports appropriate player performance metrics, ball position and trajectory information that includes those that are observed, computed and/or derived from the observations of ball trajectory, calculations of appropriate physical characteristics associated with the observations and associated conditions such as in situ and/or historical environmental, equipment used (such as specific golf club employed) and/or other pertinent information.

19. A method of claim 12 further comprising the ability to present, provide and display in a meaningful manner all measured data, calculated parameters and analysis results for a single or multiple episodes as appropriate for the sport and the analysis intent, the display of raw data and/or analysis results in multiple formats and forms for a set of standard and/or user defined results displayed in a sport appropriate manner such as combined and/or sole presentation of the episode as it occurred, the factors that influenced the result and relevant associated data required to describe the circumstances existing at the time of the episode including displays of the analysis results such as ball's travel-path information such as ball launch angle, apogee, flight distance, bounce (1^{st}, 2^{nd}, 3^{rd}, etc.) distances/characteristics (if applicable), total distance, and ball spin, the player(s) specific actions which initiated the ball trajectory, the in situ environmental conditions and other relevant features such as playing field topography.

20. A method of claim 12 further comprising the ability to display any selected set of information and/or data in 2, 3 or 4 dimensions (4^{th} dimension being time) and capability for presenting a single or multiple episodes and/or observations and associated data at the same time which includes utilization of presentation formats such as video, modeled output, simulated video, audio, simulated audio, graphical, geographically referenced, tabular, a combination of any of these formats and/or any other appropriate state of the art presentation format available or that will become available which will properly and effectively convey the data and/or information to the user or the viewer in a meaningful manner with the specific parameters to be included and the format determined by the requirements of the sport, the factors pertinent to that sport and the desires of the user.

21. The method for the access and utilization of data from any other ball position, environmental or player circumstance data or information source not specifically associated with this system to permit the computational performance functions attributed to this invention including storage, retrieval, analysis of the data and display of all relevant player action, environmental, and sport ball position and motion data all of which is to be conducted in a manner prescribed in the processes, capabilities, functions and characteristics as prescribed in other claims of this invention such as determination and presentation of ball trajectory, associated environmental conditions, specific circumstances and player's initiation actions and the assessment of performance based appropriate statistical analysis to determine the impact of the varying influences on the flight trajectory and motion characteristics of the ball, the past and/or current performance capabilities of the player and/or comparison with other players, presentation of historical results and/or other related factors where the data utilized for all of these functions and actions is solely from other external data sources and/or a combination of invention related sources and external sources.
